(19) United States
(12) Patent Application Publication
(10) Pub. No.: US 2020/0397195 A1
(43) Pub. Date: Dec. 24, 2020

(54) AUTOMATIC COOKING APPARATUS

(71) Applicant: CENZ Automation Co. Ltd., New Taipei City (TW)

(72) Inventors: Chi Chang, Taipei City (TW); Yin-Chu Pan, New Taipei City (TW); Chui-Yu Wu, New Taipei City (TW)

(73) Assignee: CENZ Automation Co. Ltd., New Taipei City (TW)

(21) Appl. No.: 16/541,201

(22) Filed: Aug. 15, 2019

(30) Foreign Application Priority Data
Jun. 18, 2019 (TW) 108120994

(51) Int. Cl. A47J 44/02; A47J 37/00

(52) U.S. Cl. CPC A47J 44/02; A47J 37/00

(57) ABSTRACT

An automatic cooking apparatus includes a storage module, at least one cooking module, a carrier module, and a collection box. The storage module is adapted to store at least one food material. The cooking module includes a cookware. The carrier module is arranged at the storage module and the cooking module. The collection box is configured to collect the food material from the storage module and transport the food material into the cookware of the cooking module by the carrying module.

### CROSS-REFERENCE TO RELATED APPLICATION

This application claims the priority benefit of Taiwan application serial no. 108120994, filed on Jun. 18, 2019. The entirety of the above-mentioned patent application is hereby incorporated by reference herein and made a part of this specification.

### BACKGROUND

### Technical Field

The disclosure relates to cooking apparatus, and more particularly, to an automatic cooking apparatus.

### Description of Related Art

With the advancement of science and technology, many new-generation automation apparatuses have gradually been able to be practically applied to general household consumption. Because of changes in eating habits, the proportion of people dining out becomes higher and higher. However, the traditional operation mode of restaurants results in the continuous increase in labor costs. Hence, the development of automation cooking apparatuses in the future should not be underestimated. Besides, at present, the automation cooking apparatus is mostly semi-automatically operated, and all the required ingredients are manually placed in a fixed container and placed next to the semi-automatic cooking apparatus. An automatic feeding action is then performed, and dishes are cooked by performing an automatic stir-frying action. If it is intended to achieve completely unmanned automatic cooking to save manpower and ensure the standardization of the amount of ingredients used, a fully automatic feeding system that can automatically provide the required ingredients for each dish to be cooked is required. In addition, most of automatic cooking apparatuses on the market are equipped with one wok, and it is not possible to cook dishes that require more cooking cookware. For instance, cooking Italian pasta requires a wok or pan to stir-fry the food materials and ingredients, and a boiling water pot is needed to cook the pasta noodles. After the noodles are half cooked and picked up from the pot, the noodles are put into the wok or pan and stir-fried together with the food materials and ingredients in the wok or pan. Some food materials of Chinese dish are required to be fried and then put into the wok and stir-fried with other food materials. Hence, cooking such dishes requires the use of the wok or pan and the oil pan. To cook other dishes, some food materials are sometimes required to be blanched and then put into the wok and stir-fried with other food materials. In this case, the wok (or pan in all applications) and the boiling water pot are required. In addition to the wok, the secondary auxiliary cooking unit required for different dishes may vary and is not limited to the oil pan and the boiling water pot, such as a steamer, an oven, a microwave oven, or a combi-cookware capable of performing multiple cooking processes, e.g., a steam oven. As such, how the automated cooking apparatus can truly achieve complete automation of feeding and cooking and automatically cook more types of dishes by automatically using more pot combinations for cooking is a development goal.

Besides, there have been plenty of food safety problems in recent years, and the automated cooking apparatus usually requires many mechanisms for transporting food materials. The containers and pipelines that may come into contact with food must keep clean and must be easy to clean for a long time to ensure food safety. Hence, how to easily maintain the cleanness of the automated cooking apparatus is a crucial issue.

### SUMMARY

The disclosure provides an automatic cooking apparatus whose containers and pipelines in contact with food materials can be automatically cleansed to ensure sanitation.

According to an embodiment of the disclosure, an automatic cooking apparatus including a storage module, at least one cooking module, a carrier module, and a collection box is provided. The storage module is adapted to store at least one food material. The at least one cooking module includes a cookware. The carrier module is arranged at the storage module and the cooking module. The collection box is configured to collect the food material from the storage module and transport the food material into the cookware of the cooking module by the carrying module.

In an embodiment of the disclosure, the carrier module includes a first rail and a second rail. The first rail is connected between the storage module and the at least one cooking module. The collection box is adapted to move along the first rail to transport the at least one food material to the at least one cooking module. The second rail is arranged at the at least one cooking module, and the collection box is adapted to move along the second rail in the at least one cooking module.

In an embodiment of the disclosure, the first rail and the second rail constitute a continuous rail.

In an embodiment of the disclosure, an extension direction of the first rail and an extension direction of the second rail are the same.

In an embodiment of the disclosure, the at least one cooking module includes a plurality of cooking modules, and the first rail is connected among the cooking modules.

In an embodiment of the disclosure, the at least one cooking module further includes a heating unit and an auxiliary cooking unit. The auxiliary cooking unit is adapted to perform pre-treatment on the at least one food material and transport the pre-heated at least one food material into the cookware after the pre-heating treatment. The second rail extends between the auxiliary cooking unit and the heating unit, and the collection box is adapted to move along the second rail to the auxiliary cooking unit or the heating unit.

In an embodiment of the disclosure, the storage module includes a first cleansing unit, and the collection box is adapted to move to the first cleansing unit, so as to allow the first cleansing unit to cleanse the collection box.

In an embodiment of the disclosure, the automatic cooking apparatus further includes a vertical rail, a transverse rail, and a holding platform. The vertical rail is arranged in the storage module. The transverse rail is movably connected to the vertical rail and adapted to vertically move along the vertical rail. The holding platform is arranged on the transverse rail and adapted to hold the collection box, and the holding platform moves along the transverse rail to drive the collection box to move in a transverse manner.

In an embodiment of the disclosure, the automatic cooking apparatus further includes a third rail and a meal delivering module, wherein the at least one cooking module further includes a heating unit, and the third rail extends between the heating unit and the meal delivering module, wherein the cookware is adapted to move along the third rail to the heating unit or the meal delivering module.

In an embodiment of the disclosure, the automatic cooking apparatus further includes a third rail, wherein the at least one cooking module includes a heating unit and a second cleansing unit, and the third rail extends between the heating unit and the cleansing unit, wherein the cookware is adapted to move along the third rail to the heating unit or the cleansing unit.

In an embodiment of the disclosure, the automatic cooking apparatus further includes at least one seasoning providing module connected to the storage module, wherein the storage module is adapted to store at least one seasoning, and the at least one seasoning providing module is configured to provide the at least one seasoning to the cookware.

In an embodiment of the disclosure, the at least one seasoning providing module includes a spraying assembly and a liquid seasoning supply tank, the spraying assembly has a buffer portion and an outlet portion communicating with each other, an inner diameter of the buffer portion is greater than an inner diameter of the outlet portion, and at least one powder seasoning is sprayed into the cookware through the outlet portion after passing through the buffer portion.

In an embodiment of the disclosure, the at least one seasoning providing module includes a cantilever, a spraying assembly, and a liquid seasoning supply tank, the spraying assembly and the liquid seasoning supply tank are connected to the cantilever, and the cantilever is adapted to drive the spraying assembly and the liquid seasoning supply tank to move above the cookware.

In an embodiment of the disclosure, the at least one cooking module includes a plurality of cooking modules, and the cantilever is adapted to drive the spraying assembly and the liquid seasoning supply tank to move between two of the cooking modules.

According to an embodiment of the disclosure, an automatic cooking apparatus including a storage module, at least one cooking module, and a carrier module is provided. The storage module is adapted to store at least one food material. The at least one cooking module includes a cookware and an auxiliary cooking unit. Here, the auxiliary cooking unit is adapted to perform pre-treatment on the at least one food material and transport the pre-heated at least one food material into the cookware after the pre-heating treatment. The carrier module is arranged at the storage module and the at least one cooking module, and the at least one food material is adapted to be transported from the storage module to the at least one cooking module by the carrier module.

In an embodiment of the disclosure, the automatic cooking apparatus further includes a collection box configured to collect the at least one food material from the storage module and move along the first rail to transport the at least one food material into the cookware or the auxiliary cooking unit of the at least one cooking module.

In an embodiment of the disclosure, the carrier module includes a first rail and a second rail. The first rail is connected between the storage module and the at least one cooking module. The collection box is adapted to move along the first rail to transport the at least one food material to the at least one cooking module. The second rail is arranged at the at least one cooking module, and the collection box is adapted to move along the second rail in the at least one cooking module.

In an embodiment of the disclosure, the first rail and the second rail constitute a continuous rail.

In an embodiment of the disclosure, an extension direction of the first rail and an extension direction of the second rail are the same.

In an embodiment of the disclosure, the at least one cooking module includes a plurality of cooking modules, and the first rail is connected among the cooking modules.

In an embodiment of the disclosure, the at least one cooking module further includes a heating unit. The second rail extends between the auxiliary cooking unit and the heating unit, and the collection box is adapted to move along the second rail to the auxiliary cooking unit or the heating unit.

In an embodiment of the disclosure, the storage module includes a first cleansing unit, and the collection box is adapted to move to the first cleansing unit, so as to allow the first cleansing unit to cleanse the collection box.

In an embodiment of the disclosure, the automatic cooking apparatus further includes a vertical rail, a transverse rail, and a holding platform. The vertical rail is arranged in the storage module. The transverse rail is movably connected to the vertical rail and adapted to vertically move along the vertical rail. The holding platform is arranged on the transverse rail and adapted to hold the collection box, and the holding platform moves along the transverse rail to drive the collection box to move in a transverse manner.

In an embodiment of the disclosure, the automatic cooking apparatus further includes a third rail and a meal delivering module, wherein the at least one cooking module further includes a heating unit, and the third rail extends between the heating unit and the meal delivering module, wherein the cookware is adapted to move along the third rail to the heating unit or the meal delivering module.

In an embodiment of the disclosure, the automatic cooking apparatus further includes a third rail, wherein the at least one cooking module includes a heating unit and a second cleansing unit, and the third rail extends between the heating unit and the cleansing unit, wherein the cookware is adapted to move along the third rail to the heating unit or the cleansing unit.

In an embodiment of the disclosure, the automatic cooking apparatus further includes at least one seasoning providing module connected to the storage module, wherein the storage module is adapted to store at least one seasoning, and the at least one seasoning providing module is configured to provide the at least one seasoning to the cookware.

In an embodiment of the disclosure, the at least one seasoning providing module includes a spraying assembly and a liquid seasoning supply tank, the spraying assembly has a buffer portion and an outlet portion communicating with each other, an inner diameter of the buffer portion is greater than an inner diameter of the outlet portion, and at least one powder seasoning is sprayed into the cookware through the outlet portion after passing through the buffer portion.

In an embodiment of the disclosure, the at least one seasoning providing module includes a cantilever, a spraying assembly, and a liquid seasoning supply tank, the spraying assembly and the liquid seasoning supply tank are connected to the cantilever, and the cantilever is adapted to drive the spraying assembly and the liquid seasoning supply tank to move above the cookware.

In an embodiment of the disclosure, the at least one cooking module includes a plurality of cooking modules, and the cantilever is adapted to drive the spraying assembly and the liquid seasoning supply tank to move between two of the cooking modules.

In view of the above, in the automatic cooking apparatus provided in one or more embodiments of the disclosure, the combination of the carrier module and the collection box allows the collection box to collect the food material from the storage module and transport the food material into the cookware of the cooking module by the carrier module. As such, it is not necessary to transport the food material through long-distance and complicated pipelines, and therefore the food material can be prevented from being left, which may lead to sanitation issues. Besides, the carrier module can be moved to the cooking modules. This design allows the automatic cooking apparatus provided herein to be equipped with a plurality of cooking modules, and no additional storage module is required. That is, the collection box can transport the food material to each cooking module by the carrier module, and therefore the cooking modules can share one storage module. As such, the collection box provided herein can be cleansed easily and is easy to be expanded and shared. In addition, the auxiliary cooking unit provided in one or more embodiments of the disclosure can perform the pre-heating treatment on the food material, so as to increase the variety of food and dishes adapted to the automatic cooking apparatus, which brings utility to the automatic cooking apparatus provided herein.

To make the above features and advantages provided in one or more of the embodiments of the disclosure more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles described herein.

FIG. 1A is a schematic three-dimensional view illustrating an automatic cooking apparatus according to an embodiment of the disclosure.

FIG. 1B is a schematic three-dimensional view illustrating the automatic cooking apparatus depicted in FIG. 1A at another view angle.

FIG. 2A is a schematic partial view illustrating a collection box of the automatic cooking apparatus depicted in FIG. 1A and located at a first location.

FIG. 2B is a schematic partial view illustrating a collection box of the automatic cooking apparatus depicted in FIG. 2A and located at a second location.

FIG. 3 is a schematic partial view illustrating a storage module of the automatic cooking apparatus depicted in FIG. 1A.

FIG. 4 is a schematic three-dimensional view illustrating a collection box of the automatic cooking apparatus depicted in FIG. 1A.

FIG. 5 is a schematic view of a first cleansing unit of the storage module depicted in FIG. 3.

FIG. 6A is a schematic view illustrating a storage module of the automatic cooking apparatus depicted in FIG. 3.

FIG. 6B is a schematic view illustrating a storage module of an automatic cooking apparatus according to another embodiment of the disclosure.

FIG. 7A is a schematic partial view illustrating the automatic cooking apparatus depicted in FIG. 1A at another view angle.

FIG. 7B is a schematic partial view illustrating an automatic cooking apparatus according to still another embodiment of the disclosure.

FIG. 8A is a schematic three-dimensional view illustrating auxiliary cooking apparatus according to another embodiment of the disclosure.

FIG. 8B is a schematic three-dimensional view illustrating auxiliary cooking apparatus according to still another embodiment of the disclosure.

FIG. 8C is a schematic three-dimensional view illustrating auxiliary cooking apparatus according to still another embodiment of the disclosure.

FIG. 8D is a schematic three-dimensional view illustrating auxiliary cooking apparatus according to still another embodiment of the disclosure.

FIG. 9 is a schematic view illustrating a cooking module of the automatic cooking apparatus depicted in FIG. 1A.

FIG. 10 is a schematic partial view illustrating a meal delivering module of the automatic cooking apparatus depicted in FIG. 9.

FIG. 11A is a schematic three-dimensional view illustrating a seasoning providing module of the automatic cooking apparatus depicted in FIG. 1A.

FIG. 11B is a schematic three-dimensional view illustrating a spraying assembly of the seasoning providing module of the automatic cooking apparatus depicted in FIG. 11A.

FIG. 12 is a schematic view illustrating that automatic cooking apparatus is expanded to a plurality of cooking modules according to another embodiment of the disclosure.

FIG. 13 is a schematic view illustrating a carrier module of an automatic cooking apparatus according to another embodiment of the disclosure.

FIG. 14 is a schematic view illustrating a carrier module of an automatic cooking apparatus according to still another embodiment of the disclosure.

### DESCRIPTION OF THE EMBODIMENTS

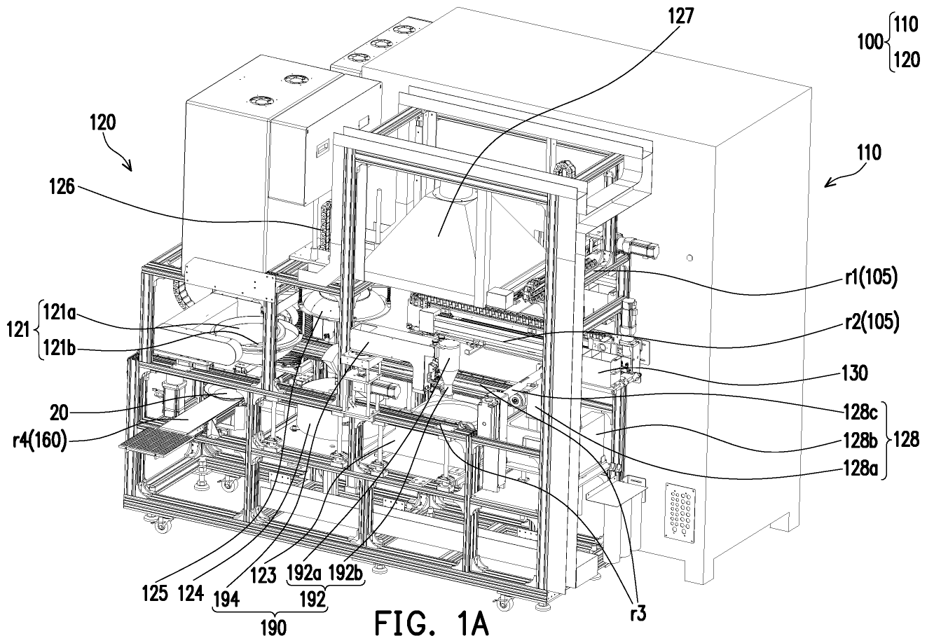

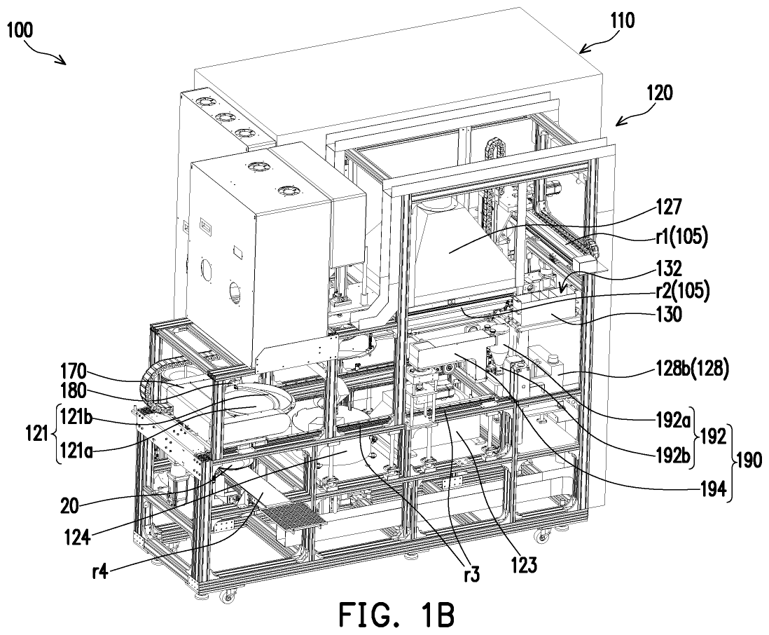

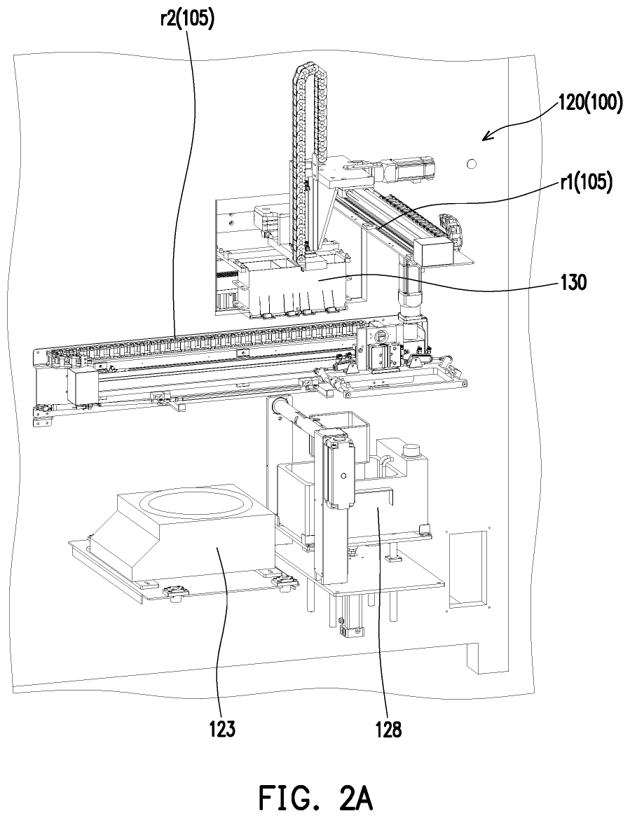

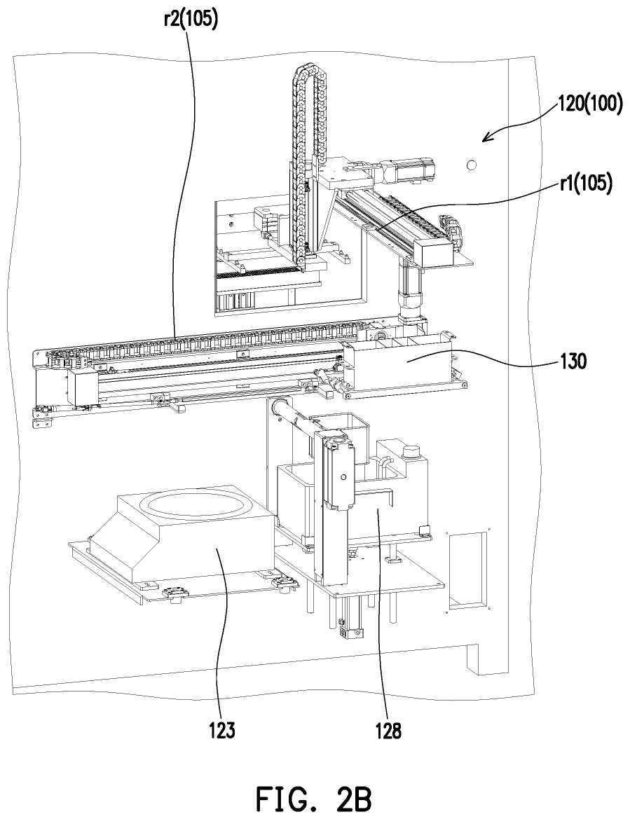

FIG. 1A is a schematic three-dimensional view illustrating an automatic cooking apparatus according to an embodiment of the disclosure. FIG. 1B is a schematic three-dimensional view illustrating the automatic cooking apparatus depicted in FIG. 1A at another view angle. FIG. 2A is a schematic partial view illustrating a collection box of the automatic cooking apparatus depicted in FIG. 1A and located at a first location. FIG. 2B is a schematic partial view illustrating a collection box of the automatic cooking apparatus depicted in FIG. 2A and located at a second location. With reference to FIG. 1A, FIG. 1B, FIG. 2A, and FIG. 2B, in the present embodiment, an automatic cooking apparatus 100 includes a storage module 110, at least one cooking module 120, a carrier module 105, and a collection box 130. The storage module 110 is adapted to store at least one food material (not shown). In the present embodiment, the storage module 110 can be implemented in form of a refrigerator, for instance, so as to store the food material and keep the food material cool at the same time, which should however not be construed as a limitation in the disclosure.

In the present embodiment, the number of at least one cooking module 120 is one as shown in the drawings, for instance, which should however not be construed as a limitation in the disclosure. The food material can be vegetables, meat, seafood, rice, noodles, and so on, which should not be construed as a limitation in the disclosure. Besides, in the present embodiment, the cooking module 120 includes a cookware 121, and the cookware 121 provided in the embodiment is illustrated in form of a wok, for instance. Certainly, in other embodiments, the cookware can also be a stew pot, a pottery pot, and so on, and the cookware can be shaped as a fry pan, a semicircular pan, or else. The basic function of the cookware is to allow the food material to be evenly heated in the cookware through stirring, shaking, vibrating, or the like, and the type of the cookware should not be construed as a limitation in the disclosure.

Specifically, in the present embodiment, the carrier module 105 is arranged at the storage module 110 and at least one cooking module 120, and at least one food material is transported to the cookware 121 of the at least one cooking module 120 by the carrier module 105.

In particular, according to the present embodiment, the carrier module 105 includes a first rail r1 and a second rail r2, and the first rail r1 is connected between the storage module 110 and the cooking module 120. The collection box 130 is configured to collect at least one food material from the storage module 110 and move along the first rail r1 to transport the food material to the cookware 121 of the cooking module 120. The second rail r2 is arranged at the cooking module 120, and the collection box 130 is adapted to move along the second rail r2 in the cooking module 120. Specifically, the collection box 130 moves along the first rail r1 to a first location in the cooking module 120 from the storage module 110 as shown in FIG. 2A and moves from the first location shown in FIG. 2A to a second location shown in FIG. 2B. The collection box 130 then moves from the first rail r1 to the second rail r2 and moves along the second rail r2, so as to transport the at least one food material into the cookware 121. Note that the locations of the collection box 130 shown in FIG. 1, FIG. 2A, and FIG. 2B are exemplary and should not be construed as limitations in the disclosure. Please refer to FIG. 1A, FIG. 1B, FIG. 2A, and FIG. 2B. In the present embodiment, the cooking module 120 further includes an auxiliary cooking unit 128. The auxiliary cooking unit 128 is basically a set of heating module and adapted to perform pre-heating treatment on the food material. After the pre-heating treatment is completed, the auxiliary cooking unit 128 transports the pre-heated food material into the cookware 121. That is, the cooking module 120 provided in the embodiment is capable of cooking dishes which require multiple cooking procedures. For instance, the auxiliary cooking unit 128 provided in the embodiment can cook some dishes that are required to undergo a blanching process, a poaching process, a deep-frying process, a steaming process, a roasting process, a microwaving process, or other pre-heating processes and can then be put into the cookware 121 for performing the subsequent cooking process. Certainly, the order of performing the pre-heating treatment processes should not be construed as a limitation in the disclosure.

With said configuration, the combination of the first rail r1 and the collection box 130 allows the collection box 130 to collect the food material from the storage module 110 and transport the food material into the cookware 121 of the cooking module 120 along the first rail r1. Since the food material need not be transported by long-distance and complicated pipelines, the sanitation issues caused by the food residues can be avoided. The first rail r1 can extend among a plurality of cooking modules 120. With such design, the automatic cooking apparatus 100 provided herein can be equipped with a plurality of cooking modules 120, and no additional storage module 110 is required because of the design of the carrier module 105. In other words, the collection box 130 and move along the first rail r1 and transport the food material to each cooking module 120, and thus the cooking modules 120 can share one storage module 110. Accordingly, the collection box 130 provided in the embodiment can be cleansed easily. In addition, the auxiliary cooking unit 128 provided in the embodiment can put the food material into the cookware 121 for additional pre-treatment, so as to increase the type of the meals and dishes adapted to the automatic cooking apparatus 100 and ensure the utility of the automatic cooking apparatus 100 provided in the embodiment.

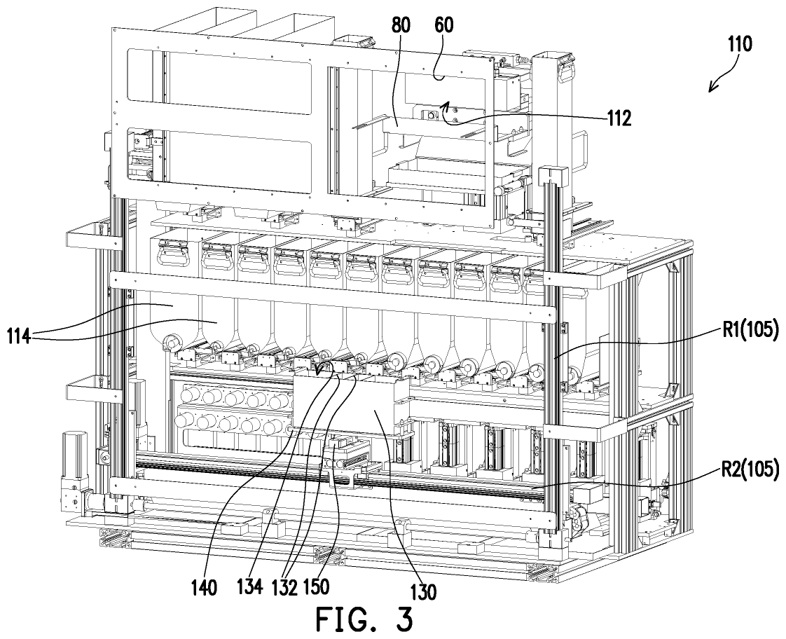

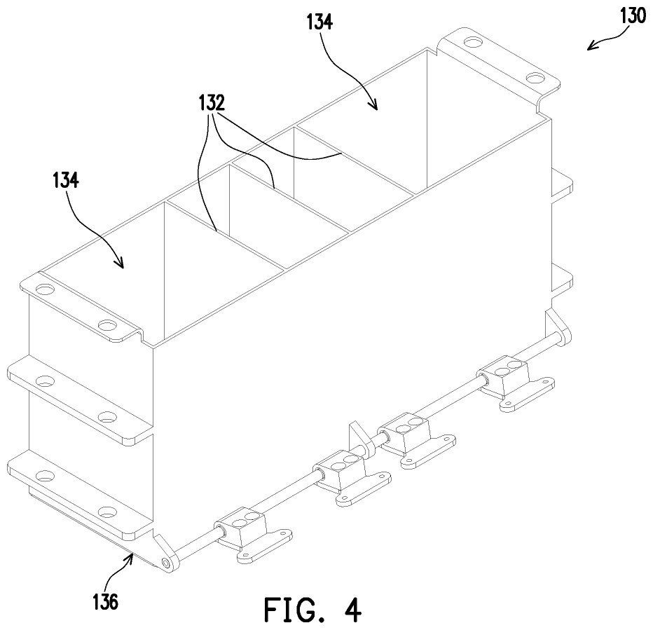

FIG. 3 is a schematic partial view illustrating a storage module of the automatic cooking apparatus depicted in FIG. 1A. FIG. 4 is a schematic three-dimensional view illustrating a collection box of the automatic cooking apparatus depicted in FIG. 1A. With reference to FIG. 3 and FIG. 4, in the present embodiment, the carrier module 105 further includes a vertical rail R1, a transverse rail r2, and a holding platform 140 arranged in the storage module 110. In the present embodiment, to clearly illustrate the structure of the storage module 110 provided in the embodiment, the casing of the storage module 110 in FIG. 3 is omitted, and the collection box 130 shown in FIG. 3 is located within the storage module 110 and can communicate with the cooking module 120 through an opening 60. Certainly, in other embodiments not shown in the drawings, the collection box 130 can communicate with the cooking module 120 in a different way, which should not be construed as a limitation in the disclosure.

On the other hand, the at least one food material provided in the embodiment is a variety of food materials, for instance, and these food materials are stored in a food material storage tank 114 of the storage module 110. Besides, as shown in FIG. 4, the collection box 130 provided in the embodiment includes a plurality of partition walls 132 and a plurality of accommodation tanks 134 partitioned by the partition walls 132, and the accommodation tanks 134 are respectively configured to accommodate the corresponding food materials.

As shown in the drawings, in the present embodiment, note that the number of the accommodation tanks 134 is four, and the number of the partition walls 132 is three, for instance. Certainly in other embodiments not shown in the drawings, the accommodation tanks 134 can have proper configurations according to actual needs and can even have only one accommodation tank 134 (no partition wall 132), and the number of the accommodation tanks 134 and the partition walls 132 should not be construed as a limitation in the disclosure.

Particularly, in the present embodiment, the transverse rail r2 can be movably connected to the vertical rail R1; namely, the transverse rail r2 provided in the embodiment can vertically move along the vertical rail R1. The holding platform 140 provided in the embodiment is arranged on the transverse rail r2, and the holding platform 140 moves along the transverse rail R2. Besides, the holding platform 140 provided in the embodiment is configured to hold the collection box 130.

With such design, the holding platform 140 can drive the collection box 130 to move below the corresponding food material storage tank 114 in a transverse manner and a vertical manner to collect the required food material. To be specific, the holding platform 140 can drive the accommodation tanks 134 corresponding to certain food materials in the collection box 130 to move below the specific food material storage tanks 114, so as to allow the collection box 130 to sequentially collect the required food materials into the specific accommodation tanks 134.

In the present embodiment, note that the type of the food material storage tank 114 should not be construed as a limitation in the disclosure; that is, the food material storage tank 114 need not be made in the manner as shown in FIG. 3 and can be designed differently in response to the different types of the food materials, which should not be construed as limitations in the disclosure.

Specifically, as shown in FIG. 3, in the present embodiment, the automatic cooking apparatus 100 further includes a weighing unit 150 arranged below the holding platform 140 and connected to the holding platform 140. Hence, the weighing unit 150 moves together with the holding platform 140 and the collection box 130. As such, the weighing unit 150 provided in the embodiment is configured to weigh the food material collected by the collection box 130, so as to ensure that the collection box 130 can collect the food material with the right weight.

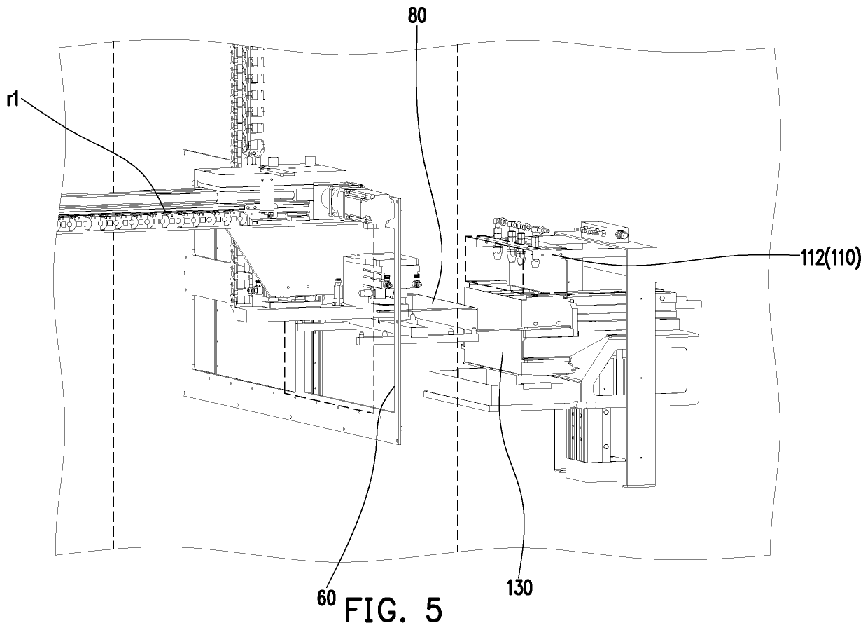

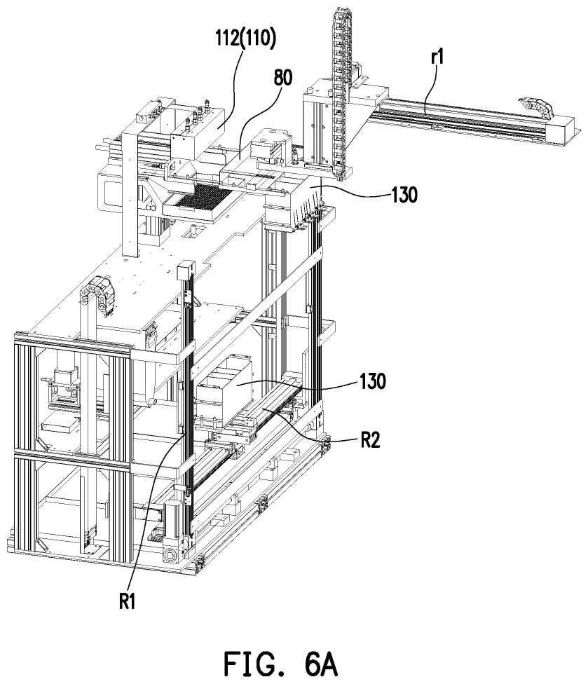

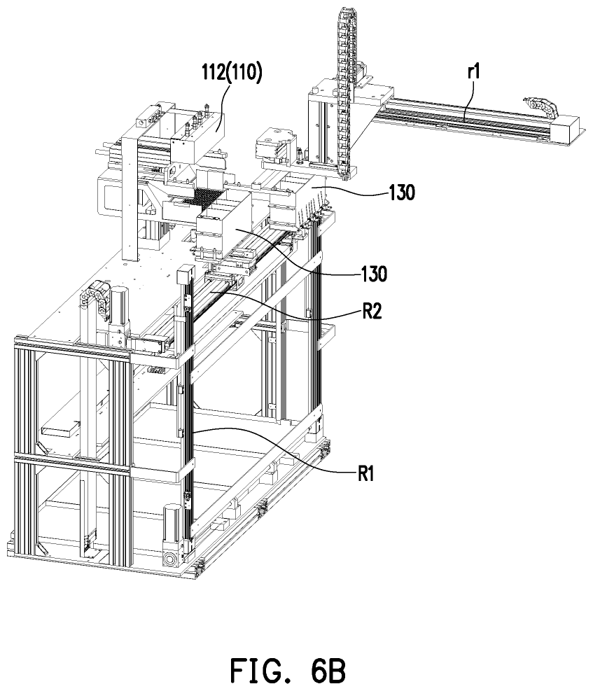

FIG. 5 is a schematic view of a first cleansing unit of the storage module depicted in FIG. 3. FIG. 6A is a schematic view illustrating a storage module of the automatic cooking apparatus depicted in FIG. 3. With reference to FIG. 3, FIG. 5, and FIG. 6A, in the present embodiment, the storage module 110 includes a first cleansing unit 112. Here, the transverse rail R2 can vertically move along the vertical rail R1 and drive the collection box 130 to be moved upwards and to the first cleansing unit 112. After the collection box 130 is used and required to be cleansed, the collection box 130 is adapted to move to the first cleansing unit 112, so that the first cleansing unit 112 can cleanse the collection box 130 and make sure it is clean.

To be specific, as shown in FIG. 5, the first cleansing unit 112 provided in the embodiment is disposed at the rear side of the storage module 110. Here, the first cleansing unit 112 is equipped with a nozzle, a brush, or the like, for instance; however, the disclosure is not limited thereto. Certainly, in other embodiments, the first cleansing unit 112 can be disposed at another proper location, which should not be construed as a limitation in the disclosure.

Please refer to FIG. 2A, FIG. 3, and FIG. 6A. In the present embodiment, as shown in FIG. 6A and FIG. 3, while the vertical rail R1 is driving the collection box 130 to move upwards, a bracket 80 may block the way, so that the collection box 130 cannot be directly transported to the first rail r1. Therefore, in the present embodiment, the vertical rail R1 transports the collection box 130 to the first cleansing unit 112, and the first cleansing unit 112 is moved downwards and receives the collection box 130. The collection box 130 is then transported to the first rail r1 through the first cleansing unit 112. Certainly, in other embodiments, it is not necessary for the collection box 130 to pass through the first cleansing unit 112, which should however not be construed as a limitation in the disclosure.

FIG. 6B is a schematic view illustrating a storage module of an automatic cooking apparatus according to another embodiment of the disclosure. For instance, with reference to FIG. 6B, the difference between the embodiment shown in FIG. 6B and the previous embodiments lies in that there is no bracket 80 in FIG. 6B. Accordingly, in the present embodiment, the transverse rail r2 vertically moves along the vertical rail R1 and directly drives the collection box 130 to the first rail r1, so that the collection box 130 is directly moved to the cooking module 120 along the first rail r1.

In brief, according to the embodiment shown in FIG. 6A, the first cleansing unit 112 serves as a checkpoint, and the collection box 130 is moved to the first rail r1 through the first cleansing unit 112. According to the embodiment shown in FIG. 6B, the collection box 130 does not pass through the first cleansing unit 112 but is directly moved to the first rail r1. Certainly, in other embodiments not shown in the drawings, the way in which the collection box is moved is exemplary, and how the collection box is moved should not be construed as a limitation in the disclosure.

To clearly explain the moving track of the collection box 130 in the embodiment shown in FIG. 6A and FIG. 6B, two collection boxes 130 are illustrated in FIG. 6A and FIG. 6B; however, the number of the collection box 130 is merely exemplary and should not be construed as a limitation in the disclosure. Besides, the internal structure of the storage module 110 is omitted in FIG. 6A and FIG. 6B, e.g., the food material storage tank 114 and the like, which should not be construed as a limitation in the disclosure.

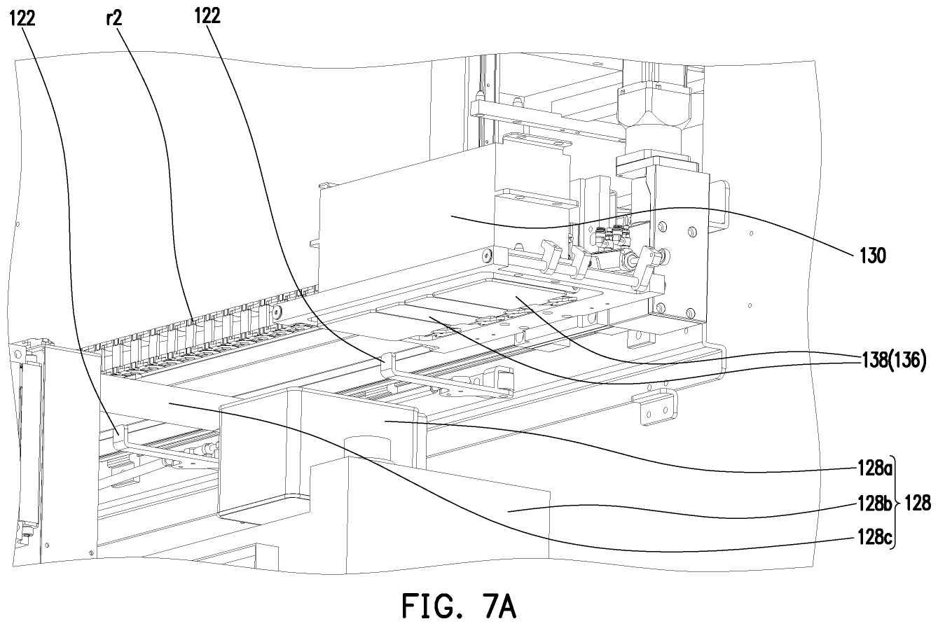

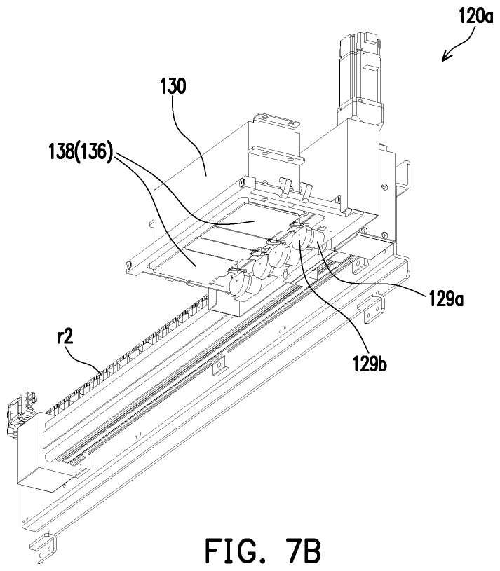

FIG. 7A is a schematic partial view illustrating the automatic cooking apparatus depicted in FIG. 1A at another view angle. With reference to FIG. 2A, FIG. 2B, FIG. 4, and FIG. 7A, in the present embodiment, a bottom 136 of the collection box 130 has a plurality of gates 138 corresponding to the accommodation tanks 134. Besides, each gate 138 is adapted to be rotated and opened, so as to allow the food materials in the corresponding accommodation tanks 134 to drop and fall into the cookware 121 (shown in FIG. 2B) or the auxiliary cooking unit 128. Additionally, in the present embodiment, note that the auxiliary cooking unit 128 is illustrated as a combination of a strainer 128a and an oil pan 128b, and the strainer 128a is connected to a pivoting arm 128c.

As shown in FIG. 2A and FIG. 2B, specifically, the automatic cooking apparatus 100 provided in the embodiment further includes a second rail r2. The cooking module 120 further includes a heating unit 123. Besides, the second rail r2 extends between the auxiliary cooking unit 128 and the heating unit 123, wherein the collection box 130 is adapted to move above the auxiliary cooking unit 128 or the heating unit 123 along the second rail r2.

With reference to FIG. 2A, FIG. 2B, and FIG. 7A, to be specific, the cooking module 120 provided in the embodiment can selectively include at least one head-pushing member 122 configured to head-push each gate 138, so as to rotate and open the gates 138. In detail, the number of the head-pushing member 122 provided in the embodiment is two, for instance, and the two head-pushing members 122 are respectively disposed at corresponding locations on the cookware 121 (shown in FIG. 2B) and the auxiliary cooking unit 128.

As such, when the collection box 130 moves above the cookware 121 or the auxiliary cooking unit 128, the head-pushing members 122 are located between the collection box 130 and the cookware 121 or the auxiliary cooking unit 128. Besides, in the present embodiment, the head-pushing members 122 can move below the corresponding gates 138 along a transverse direction. At this time, the collection box 130 is moved downwards, and the head-pushing members 122 head-push the corresponding gates 138, so as to rotate and open the gates 138. Certainly, in other embodiments, the number of the head-pushing members 122 may not be two and should not be construed as a limitation in the disclosure.

FIG. 7B is a schematic partial view illustrating an automatic cooking apparatus according to still another embodiment of the disclosure. With reference to FIG. 7B, the difference between the cooking module 120a provided in the embodiment and the cooking module 120 provided in the previous embodiments lies in that the cooking module 120a provided in the present embodiment opens the gates 138 with use of an electric lid lifting unit 129. Specifically, the electric lid lifting unit 129 is disposed at the bottom 136 of the collection box 130, and the electric lid lifting unit 129 includes a motor 129a and a pushing member 129b connected to the motor 129a. As such, when the collection box 130 moves above the cookware 121 or the auxiliary cooking unit 128, the motor 129a drives the corresponding pushing member 129b to rotate, so as to open the gates 138. Certainly, in other embodiments not shown in the drawings, the gates 138 can be opened in another way, which should not be construed as a limitation in the disclosure.

In particular, when the dishes to be cooked require a frying process, the collection box 130 provided in the embodiment drops the food material into the strainer 128a through the gates 138. At this time, the oil pan 128b moves upwards and fries the food material in the strainer 128a. After the frying process is completed, the pivoting arm 128c turns the strainer 128a upside down, so as to transport the food material in the strainer 128a into the cookware 121 (shown in FIG. 1B).

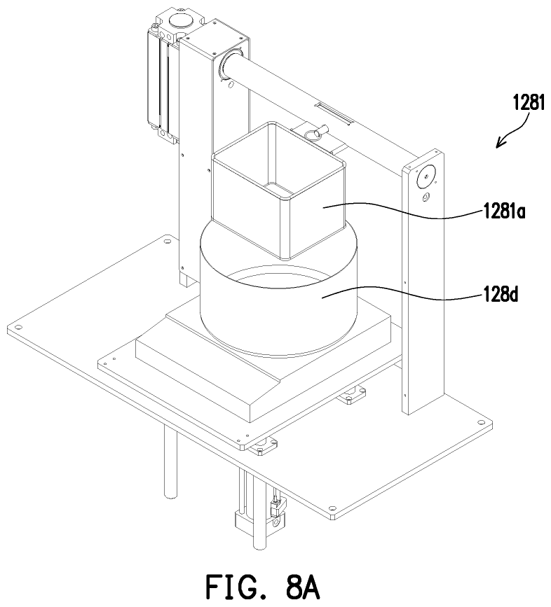

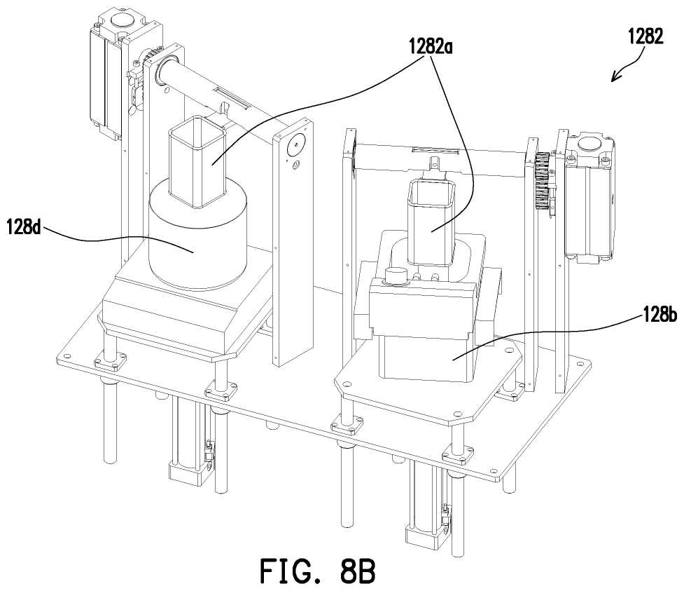

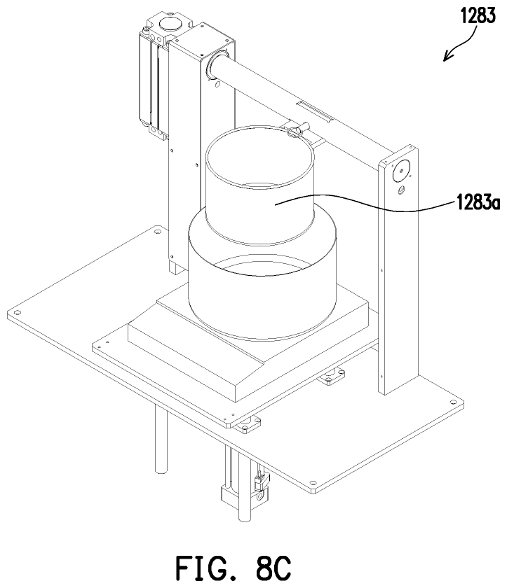

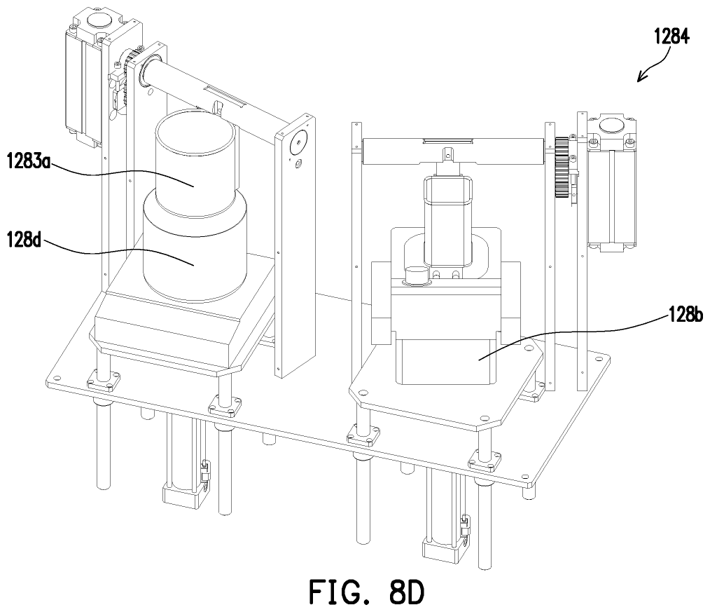

FIG. 8A is a schematic three-dimensional view illustrating auxiliary cooking apparatus according to another embodiment of the disclosure. FIG. 8B is a schematic three-dimensional view illustrating auxiliary cooking apparatus according to still another embodiment of the disclosure. FIG. 8C is a schematic three-dimensional view illustrating auxiliary cooking apparatus according to still another embodiment of the disclosure. FIG. 8D is a schematic three-dimensional view illustrating auxiliary cooking apparatus according to still another embodiment of the disclosure. With reference to FIG. 7A and FIG. 8A to FIG. 8D, in other embodiments, the auxiliary cooking unit 128 need not be as shown in FIG. 7A and need not be in form of the oil pan 128b; it is also likely for the auxiliary cooking unit 1281 to be in form of a boiling water pot 128 shown in FIG. 8A or for the auxiliary cooking unit 1282 to be in form of a combination of an oil pan 128b and a boiling water pot 128d shown in FIG. 8B. The type of the auxiliary cooking unit should not be construed as a limitation in the disclosure.

Besides, in other embodiments, the shape of the strainer not only can be the shape of the strainer 128a shown in FIG. 7A but also can be the shape of the strainer 1281a shown in FIG. 8A, the shape of the strainer 1282a shown in FIG. 8B, or the shape of the strainer 1283a of the auxiliary cooking unit 1283 shown in FIG. 8C and FIG. 8D. The type and the shape of the strainer should not be construed as limitations in the disclosure.

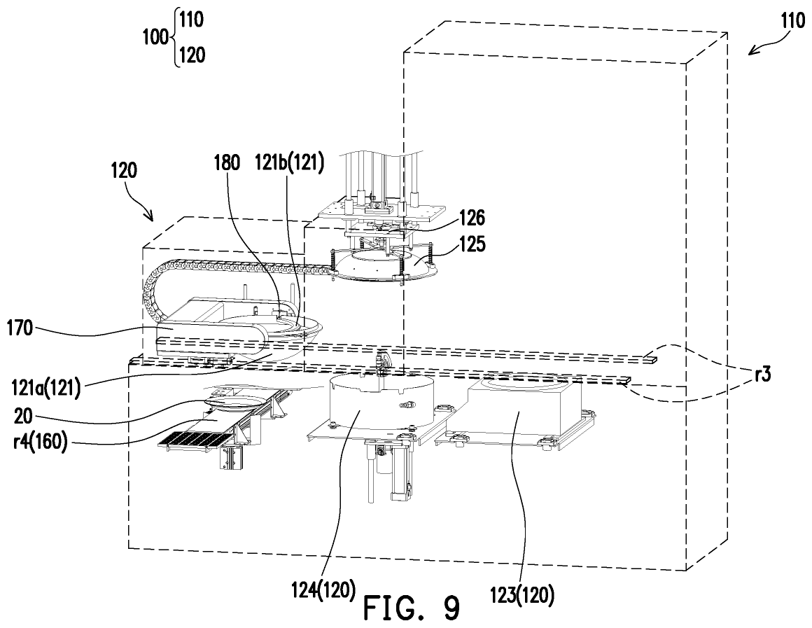

FIG. 9 is a schematic view illustrating a cooking module of the automatic cooking apparatus depicted in FIG. 1A. With reference to FIG. 2A, FIG. 2B, and FIG. 9, in the present embodiment, the cooking module 120 can selectively include a second cleansing unit 124. The automatic cooking apparatus 100 further includes a meal delivering module 160. The automatic cooking apparatus 100 further includes a third rail r3. Besides, the third rail r3 provided in the embodiment sequentially extends among the heating unit 123, the second cleansing unit 124, and the meal delivering module 160. Thereby, the cookware 121 is adapted to move along the third rail r3 to the heating unit 123, the second cleansing unit 124, or the meal delivering module 160. Besides, to clearly illustrate the relative locations of the heating unit 123, the second cleansing unit 124, and the meal delivering module 160 provided in the embodiment, the third rail r3 in FIG. 9 is depicted in dotted lines, and its detailed structure is omitted; however, the disclosure is not limited thereto.

In other embodiments not shown in the drawings, note that the heating unit 123, the second cleansing unit 124, and the meal delivering module 160 need not be arranged in the manner shown in FIG. 9. That is, the relative locations of the heating unit 123, the second cleansing unit 124, and the meal delivering module 160 should not be construed as limitations in the disclosure. Additionally, the cooking module 120 is not limited to simultaneously include the heating unit 123, the second cleansing unit 124, and the meal delivering module 160. Namely, the cooking module 120 can merely include the heating unit 123 and the second cleansing unit 124 or merely include the heating unit 123 and the meal delivering module 160, which should not be construed as a limitation in the disclosure.

To be specific, as shown in FIG. 1A and FIG. 1B, the cooking module 120 can selectively include an exhaust device 127 arranged above the heating unit 123. In the present embodiment, the exhaust device 127 is, for instance, a range hood, which should however not be construed as a limitation in the disclosure. As such, when the heating unit 123 is heating the food material in the cookware 121, the range hood can draw out airborne grease generated during the cooking process, so as to prevent the airborne grease from contaminating internal mechanisms of the automatic cooking apparatus 100 provided in the embodiment.

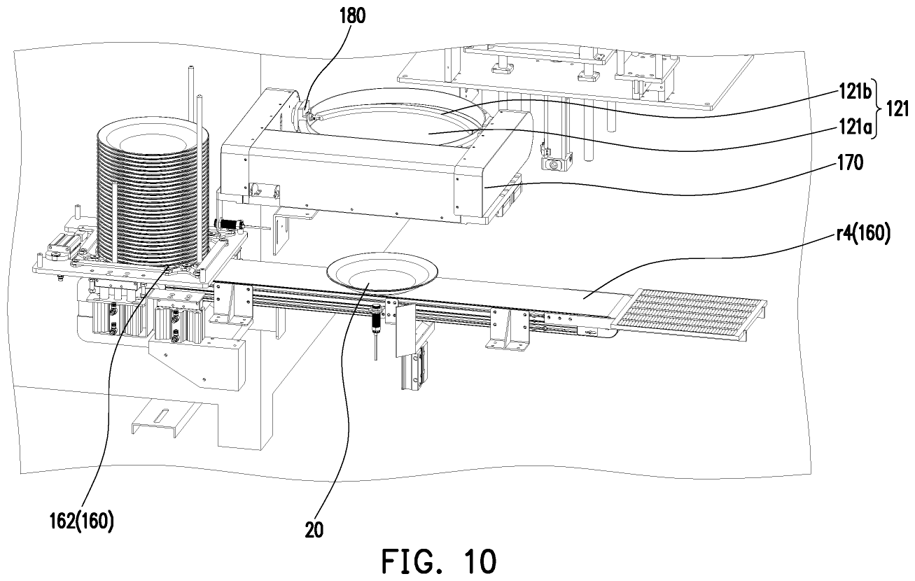

FIG. 10 is a schematic partial view illustrating a meal delivering module of the automatic cooking apparatus depicted in FIG. 9. With reference to FIG. 9 and FIG. 10, specifically, the automatic cooking apparatus 100 provided in the embodiment further includes a pedestal 170 and a rotation axle 180. The pedestal 170 is movably disposed at the third rail r3. The rotation axle 180 is pivoted to the pedestal 170 and connected to the cookware 121. In other words, the cookware 121 is connected onto the rotation axle 180, and the cookware 121 is driven by the pedestal 170 and moved among the heating unit 123, the second cleansing unit 124, and the meal delivering module 160. Besides, the rotation axle 180 is adapted to drive the cookware 121 to rotate.

As shown in FIG. 9, in the present embodiment, the cookware 121 is adapted to move along the third rail r3 to the second cleansing unit 124, so as to allow the second cleansing unit 124 to cleanse the cookware 121. Specifically, when the pedestal 170 drives the cookware 121 to move to the second cleansing unit 124, the second cleansing unit 124 is located below the cookware 121. Hence, the rotation axle 180 drives the cookware 121 to rotate, so that an inner portion of the cookware 121 can face the second cleansing unit 124 (not shown). Besides, the second cleansing unit 124 is equipped with a pot cleaning brush, a nozzle, or the like (not shown), for instance, so as to cleanse the cookware 121. After the cleansing process is completed, the rotation axle 180 drives the cookware 121 to rotate to return to the default state.

Certainly, in other embodiments, the second cleansing unit 124 need not be located below the cookware 121, and the second cleansing unit 124 can also be equipped with other cleansing apparatus. The location and the type of the second cleansing unit should not be construed as limitations in the disclosure.

With reference to FIG. 9 and FIG. 10, in the present embodiment, the meal delivering module 160 includes a fourth rail r4 and a dish providing unit 162, and the fourth rail r4 is configured to transport a container 20 of the dish providing unit 162 to pass through the meal delivering module 160. Here, the container 20 can be a plate or a bowl in any form and is configured to hold the dishes from the cookware 121, which should not be construed as a limitation in the disclosure. Specifically, in the present embodiment, after the meal is completely cooked, the pedestal 170 drives the cookware 121 to move to the meal delivering module 160. At this time, the rotation axle 180 is adapted to rotate the cookware 121, so as to transport the meal in the cookware 121 onto the container 20 of the meal delivering module 160. The container 20 then delivers the meal through the fourth rail r4.

As shown in FIG. 9 and FIG. 10, in the present embodiment, the cookware 121 includes a body 121a and a stirring component 121b. Here, the stirring component 121b is pivoted to the body 121a and located within the body 121a. Additionally, the stirring component 121b can rotate inside the cookware 121 to stir-fry at least one food material in the cookware 121. On the other hand, according to the present embodiment, the cooking module 120 further includes a lid 125 and a driving unit 126, and the driving unit 126 is adapted to drive the lid 125 to ascend or descend relative to the cookware 121. As such, if the cooking process of the meal requires the coverage of the lid 125, the lid 125 can descend by the driving unit 126 and can then cover the cookware 121.

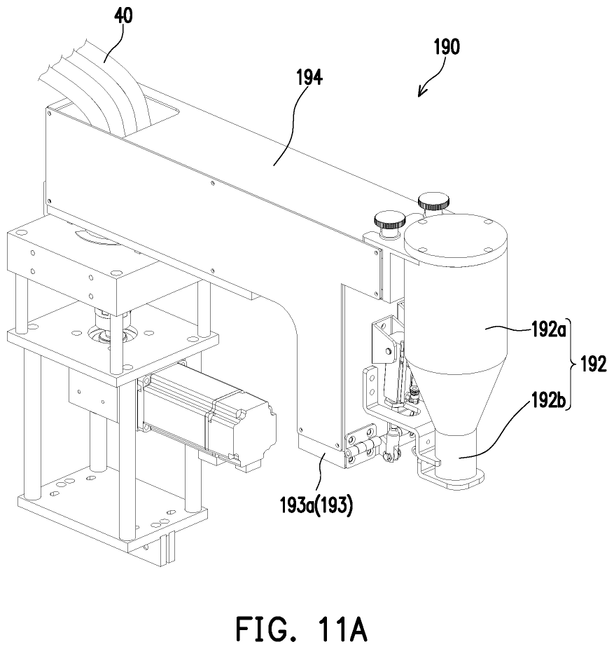

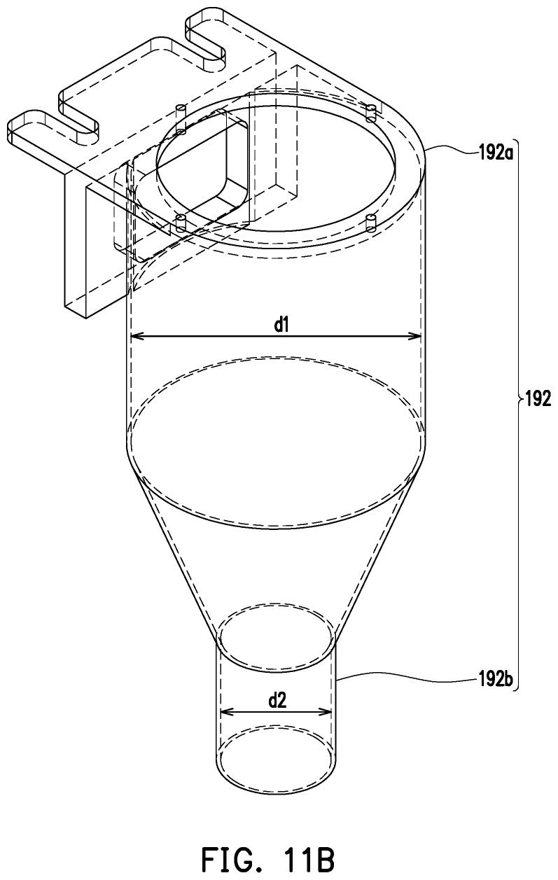

FIG. 11A is a schematic three-dimensional view illustrating a seasoning providing module of the automatic cooking apparatus depicted in FIG. 1A. FIG. 11B is a schematic three-dimensional view illustrating a spraying assembly of the seasoning providing module of the automatic cooking apparatus depicted in FIG. 11A. With reference to FIG. 1A, FIG. 1B, FIG. 11A, and FIG. 11B, in the present embodiment, the automatic cooking apparatus 100 further includes at least one seasoning providing module 190, and the seasoning providing module 190 is connected to the storage module 110 (not shown), so as to provide liquid seasoning and powder seasoning required for cooking.

For instance, in the present embodiment, the liquid seasoning and the powder seasoning are transported to the seasoning providing module 190 through different transport pipes 40. In the present embodiment, note that the transport pipes 40 shown in FIG. 8A are exemplary, and most structures of the transport pipes 40 are omitted; in other embodiments, the seasonings can be transported to the seasoning providing module 190 in another manner, which should not be construed as a limitation in the disclosure. Here, the storage module 110 is adapted to store at least one seasoning, and the storage module 110 is configured to provide the seasoning to the cookware 121. Note that the number of the at least one seasoning providing module 190 provided in the embodiment is illustrated as one; however, in other embodiments, the number of the seasoning providing module 190 can be plural and should not be construed as a limitation in the disclosure.

Particularly, in the present embodiment, the seasoning providing module 190 includes a spraying assembly 192 responsible for providing the powder seasoning and a liquid seasoning supply tank 193 responsible for providing the liquid seasoning. The spraying assembly 192 has a buffer portion 192a and an outlet portion 192b communicating with each other. In the present embodiment, note that the number of the transport pipes 40 is illustrated as four, while the number of the transport pipes 40 should not be construed as a limitation in the disclosure. Besides, some of the four transport pipes 40 are connected to the spraying assembly 192 responsible for transporting the powder seasoning, and the other transport pipes 40 are connected to the liquid seasoning supply tank 193 responsible for transporting the liquid seasoning. Certainly, in other embodiments, the type of the seasonings transported through the transport pipes 40 and how to allocate the transport pipes 40 should not be construed as limitations in the disclosure.

As shown in FIG. 11B, an inner diameter d1 of the buffer portion 192a of the spraying assembly 192 is greater than an inner diameter d2 of the outlet portion 192b, and the seasoning is sprayed into the cookware 121 through the outlet portion 192b after passing through the buffer portion 192a. Specifically, in the present embodiment, during the transporting process of the seasoning, the powder seasoning rapidly flying because of high pressure first passes through the buffer portion 192a with the greater inner diameter and is decelerated. With such design, the buffer portion 192a provided in the embodiment can prevent the seasoning from being sprayed into the cookware 121 through the outlet portion 192b due to the overly fast speed which further leads to contamination of the internal mechanisms of the automatic cooking apparatus 100 and the sanitation issues. The liquid seasoning can directly flow into the cookware 121 from the liquid seasoning supply tank 193 (the end of the transport pipes 40). For instance, the end of the transport pipes 40 is located above the lid 193a of the liquid seasoning supply tank 193, and the lid 193a can be opened to allow the liquid seasoning to flow into the cookware 121 in a downward manner, which should however not be construed as a limitation in the disclosure.

As shown in FIG. 1A, FIG. 1B, FIG. 11A, and FIG. 11B, specifically, in the present embodiment, the seasoning providing module 190 can selectively include a cantilever 194, and the spraying assembly 192 and the liquid seasoning supply tank 193 are connected to the cantilever 194. The cantilever 194 is adapted to rotate along a transverse direction and drive the spraying assembly 192 and the liquid seasoning supply tank 193 to move above the cookware 121, so as to allow the spraying assembly 192 and the liquid seasoning supply tank 193 to spray the seasoning or have the seasoning flow into the cookware 121. Certainly, in other embodiments not shown in the drawings, the spraying assembly 192 and the liquid seasoning supply tank 193 of the seasoning providing module 190 can be directly fixed above the cookware 121, and it is not necessary to arrange the cantilever 194. Alternatively, the cantilever 194 can be fixed above the cookware 121, and the spraying assembly 192 and the liquid seasoning supply tank 193 are connected to the cantilever 194, which should not be construed as a limitation in the disclosure. Besides, it is not necessary for the cantilever 194 to rotate along the transverse direction, and the way that the cantilever 194 moves and the type of the cantilever 194 should not be construed as limitations in the disclosure.

In the present embodiment, in order to clearly illustrate the internal structure of the cooking module 120, FIG. 1A, FIG. 1B, FIG. 2A, FIG. 2B, FIG. 6A, FIG. 6B, and FIG. 9 all exemplarily illustrate one cooking module 120, while the number of the cooking module 120 should not be construed as a limitation in the disclosure.

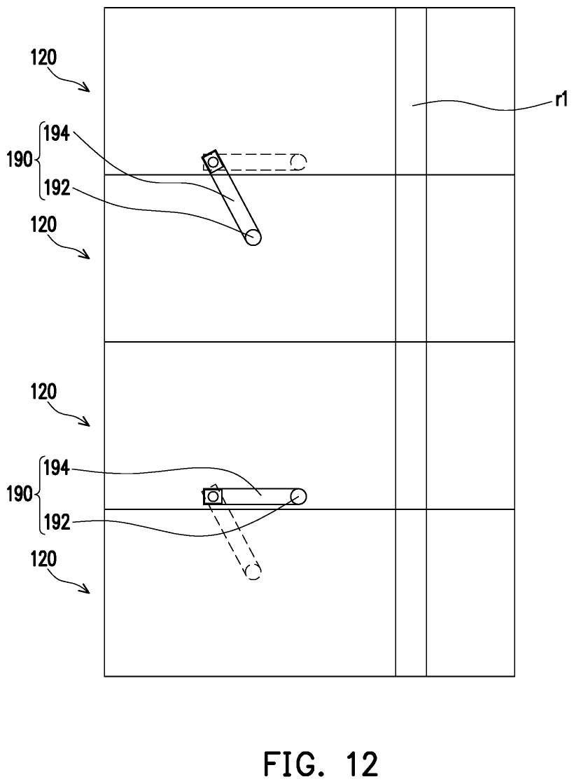

FIG. 12 is a schematic view illustrating that an automatic cooking apparatus is expanded to a plurality of cooking modules according to another embodiment of the disclosure. With reference to FIG. 6A, FIG. 6B, and FIG. 12, in the present embodiment, the at least one cooking module 120 refers to a plurality of cooking modules 120, for instance. Particularly, in the present embodiment, the first rail r1 can be connected among a plurality of cooking modules 120. As such, the collection box 130 can move to the cooking modules 120 through the first rail r1. Specifically, the automatic cooking apparatus 100 provided in the embodiment can be one storage module 110 plus a plurality of cooking modules 120 arranged along the extension direction of the first rail r1. That is, the number of the cooking modules 120 provided in the embodiment can be increased according to actual requirements, and the cooling modules 120 can be connected together by one first rail r1, so that the collection box 130 can be moved to the corresponding cooking module 120 and transmit the food material into the corresponding cookware 121 for cooking.

Besides, as shown in FIG. 1A, FIG. 1B, FIG. 11A, and FIG. 12, the cantilever 194 of the seasoning providing module 190 provided in the present embodiment can drive the spraying assembly 192 to move between two cooking modules 120. Specifically, the cantilever 194 can drive the spraying assembly 192 to move above the cookware 121 of the two adjacent cooking modules 120, so as to spray the seasoning into the corresponding cookware 121. With such design, any two cooking modules 120 can share one seasoning providing module 190 to save costs and space.

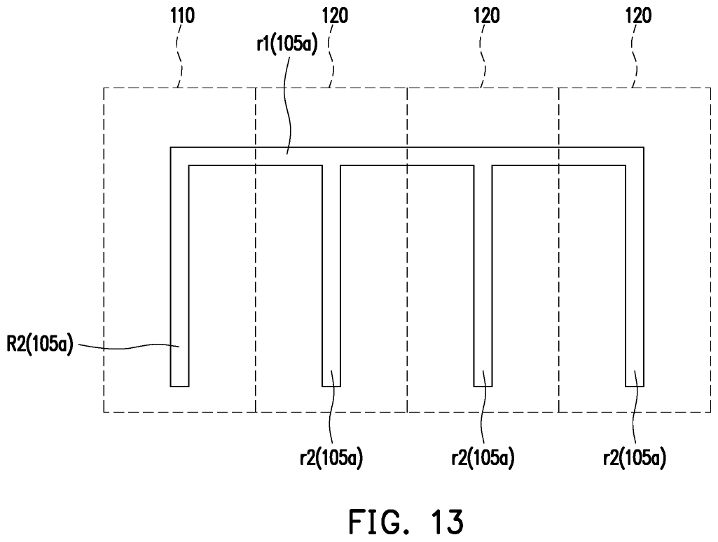

FIG. 13 is a schematic view illustrating a carrier module of an automatic cooking apparatus according to another embodiment of the disclosure. With reference to FIG. 2A, FIG. 2B, and FIG. 13, the difference between the carrier module 105a provided in the embodiment and the carrier module 105 provided in the previous embodiment (shown in FIG. 2A and FIG. 2B) lies in that the transverse rail r2, the first rail r1, and the second rail r2 of the carrier module 105a constitute a continuous rail according to the present embodiment, Specifically, the transverse rail r2, the first rail r1, and the second rail r2 provided in the embodiment are located on the same plane and have no height difference (shown in FIG. 2A and FIG. 2B).

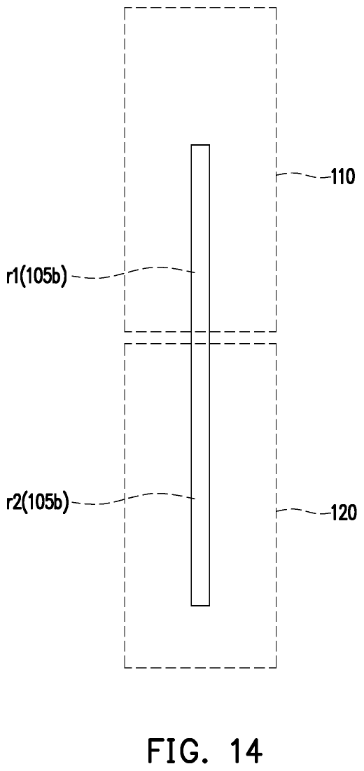

FIG. 14 is a schematic view illustrating a carrier module of an automatic cooking apparatus according to still another embodiment of the disclosure. With reference to FIG. 13 and FIG. 14, the difference between the carrier module 105b provided in the embodiment and the carrier module 105a provided in the embodiment shown in FIG. 13 lies in that the first rail r1 and the second rail r2 of the carrier module 105b provided in the present embodiment not only constitute a continuous rail but also have the same extension direction. In brief, according to the present embodiment, the first rail r1 and the second rail r2 constitute an integrated rail as a whole.

In other embodiments, note that the carrier module can be arranged in another appropriate manner according to actual requirements, and the type of the carrier module should not be construed as a limitation in the disclosure.

To sum up, in the automatic cooking apparatus provided in one or more embodiments of the disclosure, the combination of the carrier module and the collection box allows the collection box to collect the food material from the storage module and transport the food material into the cookware of the cooking module by the carrier module. Besides, the carrier module can extend and can be connected to the cooking modules. This design allows the automatic cooking apparatus provided herein to be equipped with a plurality of cooking modules, and no additional storage module is required. That is, the collection box can move and transport the food material to each cooking module by the carrier module, and therefore the cooking modules can share one storage module. As such, the collection box provided herein can be cleansed easily and is easy to be expanded and shared. In addition, the auxiliary cooking unit provided in one or more embodiments of the disclosure can perform the pre-heating treatment on the food material, so as to increase the variety of food and dishes adapted to the automatic cooking apparatus, which brings utility to the automatic cooking apparatus provided herein.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An automatic cooking apparatus comprising:
a storage module adapted to store at least one food material;
at least one cooking module comprising a cookware;
a carrier module arranged at the storage module and the at least one cooking module; and
a collection box configured to collect the at least one food material from the storage module and transport the at least one food material into the cookware of the at least one cooking module by the carrier module.

2. The automatic cooking apparatus according to claim 1, wherein the carrier module comprises a first rail and a second rail, the first rail is connected between the storage module and the at least one cooking module, the collection box is adapted to move along the first rail to transport the at least one food material to the at least one cooking module, the second rail is arranged at the at least one cooking module, and the collection box is adapted to move along the second rail in the at least one cooking module.

3. The automatic cooking apparatus according to claim 2, wherein the first rail and the second rail constitute a continuous rail.

4. The automatic cooking apparatus according to claim 3, wherein an extension direction of the first rail and an extension direction of the second rail are the same.

5. The automatic cooking apparatus according to claim 2, wherein the at least one cooking module comprises a plurality of cooking modules, and the first rail is connected among the plurality of cooking modules.

6. The automatic cooking apparatus according to claim 2, wherein the at least one cooking module further comprises a heating unit and an auxiliary cooking unit, the auxiliary cooking unit is adapted to perform pre-heating treatment on the at least one food material and transport the at least one food material into the cookware after the pre-heating treatment, the second rail extends between the auxiliary cooking unit and the heating unit, and the collection box is adapted to move along the second rail to the auxiliary cooking unit or the heating unit.

7. The automatic cooking apparatus according to claim 1, wherein the storage module comprises a first cleansing unit, and the collection box is adapted to move to the first cleansing unit, so as to allow the first cleansing unit to cleanse the collection box.

8. The automatic cooking apparatus according to claim 1, wherein the carrier module comprises:
a vertical rail arranged in the storage module;
a transverse rail movably connected to the vertical rail and adapted to vertically move along the vertical rail; and
a holding platform arranged on the transverse rail, wherein the holding platform is adapted to hold the collection box and move along the transverse rail to drive the collection box to move in a transverse manner.

9. The automatic cooking apparatus according to claim 1, further comprising a third rail and a meal delivering module, wherein the at least one cooking module further comprises a heating unit, and the third rail extends between the heating unit and the meal delivering module, wherein the cookware is adapted to move along the third rail to the heating unit or the meal delivering module.

10. The automatic cooking apparatus according to claim 1, further comprising a third rail, wherein the at least one cooking module comprises a heating unit and a second cleansing unit, and the third rail extends between the heating unit and the cleansing unit, wherein the cookware is adapted to move along the third rail to the heating unit or the cleansing unit.

11. The automatic cooking apparatus according to claim 1, further comprising at least one seasoning providing module connected to the storage module, wherein the storage module is adapted to store at least one seasoning, and the at least one seasoning providing module is configured to provide the at least one seasoning to the cookware.

12. The automatic cooking apparatus according to claim 11, wherein the at least one seasoning providing module comprises a spraying assembly and a liquid seasoning supply tank, the spraying assembly has a buffer portion and an outlet portion communicating with each other, an inner diameter of the buffer portion is greater than an inner diameter of the outlet portion, and at least one powder seasoning is sprayed into the cookware through the outlet portion after passing through the buffer portion.

13. The automatic cooking apparatus according to claim 11, wherein the at least one seasoning providing module comprises a cantilever, a spraying assembly, and a liquid seasoning supply tank, the spraying assembly and the liquid seasoning supply tank are connected to the cantilever, and the cantilever is adapted to drive the spraying assembly and the liquid seasoning supply tank to move above the cookware.

14. The automatic cooking apparatus according to claim 13, wherein the at least one cooking module comprises a plurality of cooking modules, and the cantilever is adapted to drive the spraying assembly and the liquid seasoning supply tank to move between two of the plurality of cooking modules.

15. An automatic cooking apparatus comprising:
a storage module adapted to store at least one food material;
at least one cooking module comprising a cookware and an auxiliary cooking unit, wherein the auxiliary cooking unit is adapted to perform pre-treatment on the at least one food material and transport the at least one food material into the cookware after the pre-heating treatment; and
a carrier module arranged at the storage module and the at least one cooking module, the at least one food material being adapted to be transported from the storage module to the at least one cooking module by the carrier module.

16. The automatic cooking apparatus according to claim 15, further comprising a collection box configured to collect the at least one food material from the storage module and move along the carrier module to transport the at least one food material into the cookware or the auxiliary cooking unit of the at least one cooking module.

17. The automatic cooking apparatus according to claim 16, wherein the carrier module comprises a first rail and a second rail, the first rail is connected between the storage module and the at least one cooking module, the collection box is adapted to move along the first rail to transport the at least one food material to the at least one cooking module, the second rail is arranged at the at least one cooking module, and the collection box is adapted to move along the second rail in the at least one cooking module.

18. The automatic cooking apparatus according to claim 17, wherein the first rail and the second rail constitute a continuous rail.

19. The automatic cooking apparatus according to claim 18, wherein an extension direction of the first rail and an extension direction of the second rail are the same.

20. The automatic cooking apparatus according to claim 17, wherein the at least one cooking module comprises a plurality of cooking modules, and the first rail is connected among the plurality of cooking modules.

21. The automatic cooking apparatus according to claim 17, wherein the at least one cooking module comprises a heating unit, the second rail extends between the auxiliary cooking unit and the heating unit, and the collection box is adapted to move along the second rail to the auxiliary cooking unit or the heating unit.

22. The automatic cooking apparatus according to claim 16, wherein the storage module comprises a first cleansing unit, and the collection box is adapted to move to the first cleansing unit, so as to allow the first cleansing unit to cleanse the collection box.

23. The automatic cooking apparatus according to claim 16, wherein the carrier module comprises:
a vertical rail arranged in the storage module;
a transverse rail movably connected to the vertical rail and adapted to vertically move along the vertical rail; and
a holding platform arranged on the transverse rail, wherein the holding platform is adapted to hold the collection box and move along the transverse rail to drive the collection box to move in a transverse manner.

24. The automatic cooking apparatus according to claim 15, further comprising a third rail and a meal delivering module, wherein the at least one cooking module further comprises a heating unit, and the third rail extends between the heating unit and the meal delivering module, wherein the cookware is adapted to move along the third rail to the heating unit or the meal delivering module.

25. The automatic cooking apparatus according to claim 15, further comprising a third rail, wherein the at least one cooking module comprises a heating unit and a second cleansing unit, and the third rail extends between the heating unit and the cleansing unit, wherein the cookware is adapted to move along the third rail to the heating unit or the cleansing unit.

26. The automatic cooking apparatus according to claim 15, further comprising at least one seasoning providing module connected to the storage module, wherein the storage module is adapted to store at least one seasoning, and the at least one seasoning providing module is configured to provide the at least one seasoning to the cookware.

27. The automatic cooking apparatus according to claim 26, wherein the at least one seasoning providing module comprises a spraying assembly and a liquid seasoning supply tank, the spraying assembly has a buffer portion and an outlet portion communicating with each other, an inner diameter of the buffer portion is greater than an inner diameter of the outlet portion, and at least one powder seasoning is sprayed into the cookware through the outlet portion after passing through the buffer portion.

28. The automatic cooking apparatus according to claim 26, wherein the at least one seasoning providing module comprises a cantilever, a spraying assembly, and a liquid seasoning supply tank, the spraying assembly and the liquid seasoning supply tank are connected to the cantilever, and the cantilever is adapted to drive the spraying assembly and the liquid seasoning supply tank to move above the cookware.

29. The automatic cooking apparatus according to claim 28, wherein the at least one cooking module comprises a plurality of cooking modules, and the cantilever is adapted to drive the spraying assembly and the liquid seasoning supply tank to move between two of the plurality of cooking modules.
